(19) United States
(12) Patent Application Publication
(10) Pub. No.: US 2011/0196964 A1
(43) Pub. Date: Aug. 11, 2011

(54) MANAGING EVENT TRAFFIC IN A NETWORK SYSTEM

(76) Inventors: Srikanth Natarajan, Fort Collins, CO (US); Praveen Yalagandul, San Francisco, CA (US); Bob Bethke, Fort collins, CO (US); Puneet Sharma, Palo Alto, CA (US); Sujata Banerjee, Palo Alto, CA (US)

(21) Appl. No.: 13/123,644

(22) PCT Filed: Oct. 14, 2008
(86) PCT No.: PCT/US08/79889

§ 371 Date: Apr. 11, 2011

(51) Int. Cl. G06F 15/173

(52) U.S. Cl. 709/224

(57) ABSTRACT

A network system and associated operating methods manage event storms. The network system comprises an event analysis and control engine that detects and manages events occurring on a network. The event analysis and control engine receives events from a plurality of agents, and analyzes the events according to policies specified in a policies templates database. The event analysis and control engine processes raw network packets directly with less than full packet parsing to generate a filtered stream of events based on the analysis. The event analysis and control engine propagates the filtered stream of events to a monitoring system.

### BACKGROUND

Event storms are common in any large-scale push-based monitoring systems due to mis-configuration of monitoring agents or due to noisy devices. Current monitoring systems stall or crash in the face of huge event storms and require user intervention to remedy the condition. To alleviate such performance degradation, some systems allow users to specify simple threshold-based policies and drop packets that do not satisfy the policies.

### SUMMARY

Embodiments of a network system and associated operating methods manage event storms. The network system comprises an event analysis and control engine that detects and manages events occurring on a network. The event analysis and control engine receives events from a plurality of agents, and analyzes the events according to policies specified in a policies templates database. The event analysis and control engine processes raw network packets directly with less than full packet parsing to generate a filtered stream of events based on the analysis. The event analysis and control engine propagates the filtered stream of events to a monitoring system. In at least some embodiments, the event analysis and control engine also reconfigures the end-agents, where possible, to reduce the event rate.

### BRIEF DESCRIPTION OF THE DRAWINGS

Embodiments of the invention relating to both structure and method of operation may best be understood by referring to the following description and accompanying drawings:

FIG. 1 is a schematic block diagram showing an embodiment of a network system adapted for handling event storms;

FIG. 2 is a schematic block diagram depicting an embodiment of an article of manufacture that implements event traffic management including event storm handling;

FIG. 3 is a schematic block diagram illustrating another embodiment of a network system that manages event traffic including handling of event storms;

FIGS. 4A through 4F are flow charts showing one or more embodiments or aspects of a computer-executed method for managing event traffic in a network system; and

FIG. 5 is a graph depicting an example time sample of event traffic in a network.

### DETAILED DESCRIPTION

System and method embodiments of a scalable event analysis and control engine manage event traffic from multiple sources and can handle event storms.

Embodiments of a scalable event analysis and control engine can monitor event streams with small memory and computation footprint and enable users to specify one or more of multiple different policies on monitored event streams, and shape the event traffic so that a monitoring system does not crash or stall. The depicted event analysis and control engine also can reconfigure end-agents to reduce event traffic. For scalability, the event analysis and control engine enable selection of efficient approximate counting algorithms that can compute statistics over events with small memory footprint.

Embodiments of a network system can be configured with a capability to handle event storms using a closed-loop architecture that increases reliability and scalability of a network manager.

Embodiments of a network system can implement an efficient analysis algorithm with small memory foot-print for quickly locate misbehaving or mis-configured event-generators. The network system can efficiently track offending event sources, thereby improving overall system reliability and enabling immunity to large number of offending sources overrunning a system.

The disclosed event analysis and control engine and associated operating methods can address several aspects of functionality by analyzing an event traffic profile in near real-time and reporting on results of the analysis, and shaping trap traffic as appropriate to ensure that a monitoring system is not overwhelmed. Users can thus improve control event generation.

The disclosed event analysis and control engine and associated operating methods can be implemented without using large buffers or file queues, thus enabling a memory-efficient approach which reduces memory footprint. The illustrative systems and techniques can enable memory and computation efficiency by event traffic shaping, thereby selectively controlling which events or event types pass to a monitoring system.

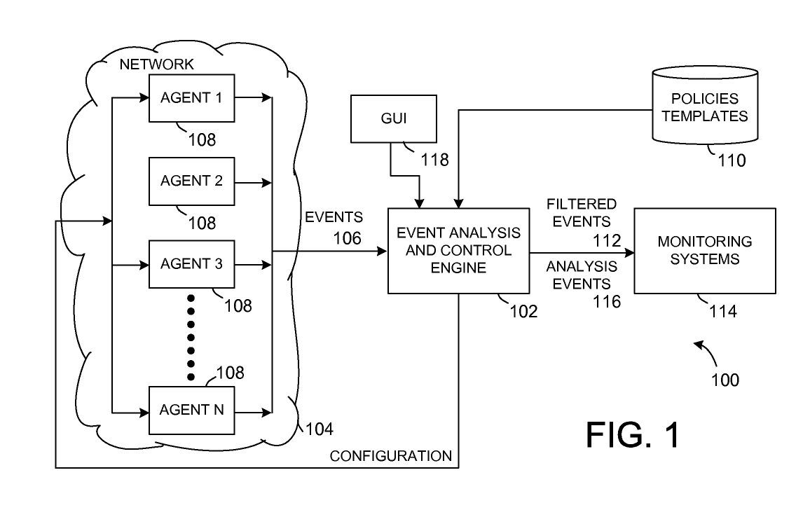

Referring to FIG. 1, a schematic block diagram illustrates an embodiment of a network system 100 for handling event storms. The depicted network system 100 comprises an event analysis and control engine 102 that detects and manages events occurring on a network 104. The event analysis and control engine 102 receives events 106 from a plurality of agents 108, and analyzes the events 106 according to policies specified in a policies templates database 110. The event analysis and control engine 102 processes raw network packets directly with less than full packet parsing to generate a filtered stream 112 of events based on the analysis. Rather than parsing the full packet header including reading all header-related bytes and creating data structures with the read values, the illustrative network system 100 operates on raw bytes and only a few portions of the header so that reading and understanding of the full header is not necessary. The portions of the header that are operated upon are selected based on the policies which are implemented. For example, if the policy is to track Top-K on sources, then the only portion of the header considered are the bits of an event that inform which end-agent sent the event. If the policy is to track Top-K on event types, then the only portion of the header considered are the bits that specify event type. Thus only a subset of the header can be read, rather than the full header. The event analysis and control engine 102 propagates the filtered stream of events to a monitoring system 114.

The policies specify aspects of multiple options within the network system such as which statistics are computed, what thresholds are used, how traffic shaping is performed, what events to report to the monitoring system, how to reconfigure the agents, and the like. For example, a policy for traffic shaping can be “drop all events from end-agent A.” Similarly, a policy for statistical computation can be “compute Top-K sources which send more than 100 events per second.”

The network system 100 can further comprise the policies templates database 110 which can be coupled to the event analysis and control engine 102 for example either directly or via a network link. The policies templates database 110 supplies policies templates for analysis. The network system 110 can further comprise the monitoring system 114 coupled to the event analysis and control engine 102 that receives filtered events and analysis events modified by shaping by the event analysis and control engine 102.

In some arrangements, the network system 100 can further comprise one or more agents 108 coupled to the event analysis and control engine 102 that receive a configuration from and communicate events to the event analysis and control engine 102. The agents 108 can be connected to the event analysis and control engine 102 by a network or other communication link, or by direct connection.

In an illustrative embodiment, the event analysis and control engine 102 can manage temporal concentrations of events by informing the monitoring system 114 and users about elevated event occurrence levels via analysis events 116. The event analysis and control engine 102 can then modify traffic by filtering the events 106 then forwarding the filtered events 112 to the monitoring system 114. The event analysis and control engine 102 then can reconfigure event-sending agents to reduce the number of events that are sent.

The event analysis and control engine 102 can be configured for conserving memory and computation consumption by leveraging optimized approximate counting data structures. In an example implementation, the counting data structures can be leveraged for continuously detecting event concentrations, for example by determining one or more statistics over the stream of events. If suitable, the statistics can be computed at different time scales. Window-based approximate counting algorithms can be used to compute the statistics.

The network system 100 can further comprise a user interface 118 coupled to the event analysis and control engine 102 that enables a user to select monitoring of different statistics at selected fine-grain and coarse-grain time scales over incoming events.

The event analysis and control engine 102 can also be configured for monitoring event streams for anomalies using analysis algorithms and by determining event traffic shaping based on the observed anomalies. Event traffic shaping can be implemented using one or more of several techniques that can be selectively activated. Example techniques can include dropping uniformly random events, dropping all events from a selected source, dropping all events of a selected event type, informing of anomalies via analysis of events with no events dropped, configuring at least one agent using database templates to reduce events from the at least one agent, and the like. Multiple of the event traffic shaping methods can be performed simultaneously.

In various implementations and/or conditions, the event analysis and control engine 102 can further be configured for analyzing and controlling event traffic in a push-based monitoring system. Similarly, the event analysis and control engine 102 can be configured for analyzing and controlling event traffic in a pull-based monitoring system wherein agents at end devices are queries for events from a central management server.

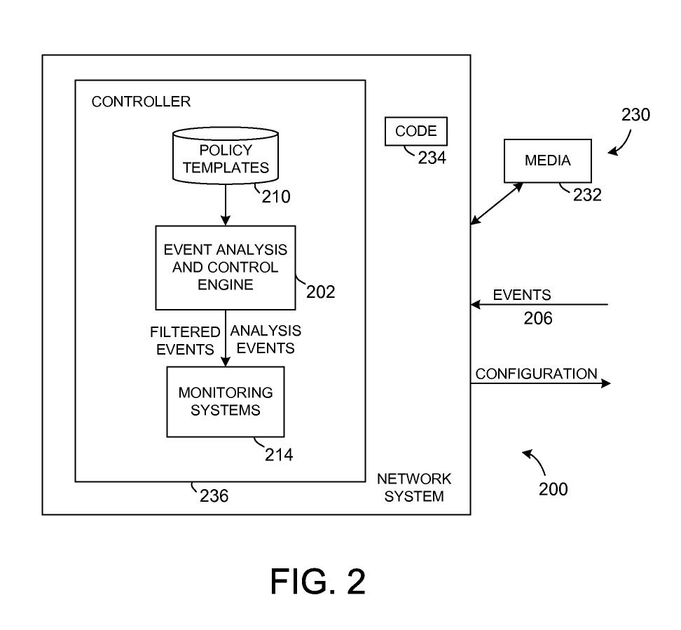

Referring to FIG. 2, a schematic block diagram depicts an embodiment of an article of manufacture 230 that implements event traffic management including event storm handling. The illustrative article of manufacture 230 comprises a controller-usable medium 232 having a computer readable program code 234 embodied in a controller 236 for managing event traffic in a network system 200. The computer readable program code 234 causes the controller 236, which implements an event analysis and control engine 202, to analyze events 206 according to policies specified in a policies database 210, process raw network packets directly with less than full packet parsing, and generate a filtered stream of events 206 based on the analysis. The program code 234 further causes the controller 236 to propagate the filtered stream of events to a monitoring system 214.

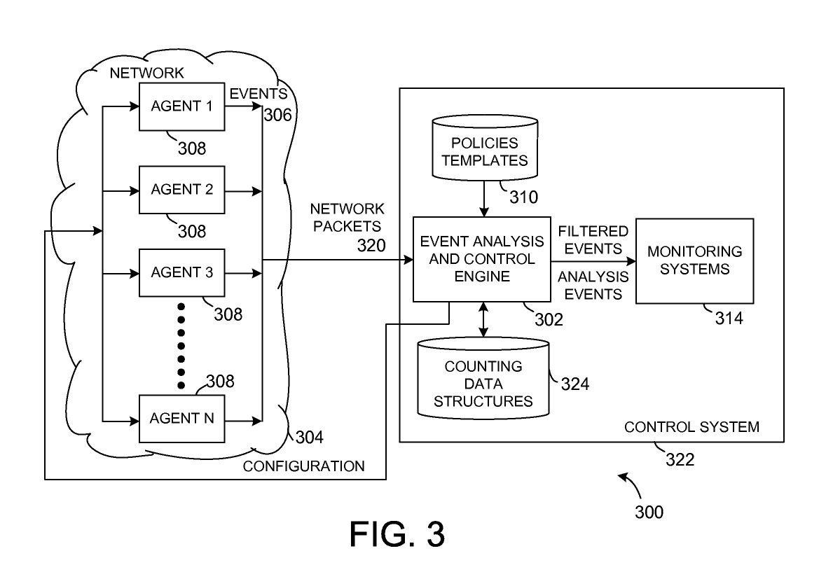

Referring to FIG. 3, a schematic block diagram illustrates another embodiment of a network system 300 that manages event traffic including handling of event storms. The illustrative network system 300 comprises an event analysis and control engine 302 that receives events 306 from multiple agents 308 and analyzes the events 306 according to policies specified in a policies templates database 310. The event analysis and control engine 302 processes raw network packets 320 directly in a closed-loop control system 322 that conserves memory and computation consumption by leveraging optimized approximate counting data structures 324, for example by continuously detecting event concentrations, determining one or more statistics over the stream of events, and applying window-based approximate counting algorithms. The closed-loop control system 322 is the loop between the end agents 308 and the analysis and control engine 302.

Since the network system 300 can automatically configure, where possible, the end-agents 308 and thus control the event rate at the sources, the configuration becomes a closed-loop control system.

The network system 300 can further comprise the policies templates database 310 coupled to the event analysis and control engine 302 that supplies policies templates for analysis. A monitoring system 314 can be coupled to the event analysis and control engine 302 receives filtered events and analysis events which are modified by shaping by the event analysis and control engine 302.

The network system 300 can further comprise one or more agents 306 coupled to the event analysis and control engine 302 that receives a configuration from and communicates events to the event analysis and control engine 302.

The event analysis and control engine 302 can be configured to detect anomalies and selectively respond to detection by temporarily terminating receipt of traps from a source agent of the anomaly, temporarily terminating receipt of a specified event from a source agent, enabling a user to control behavior according to the analysis, and spawning additional trap processors according to the analysis.

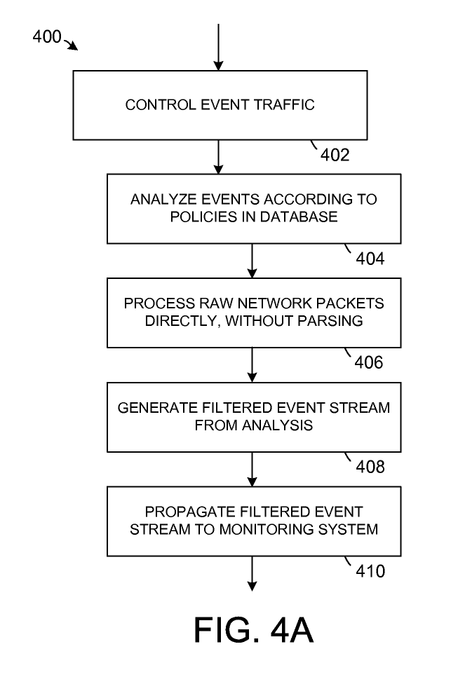

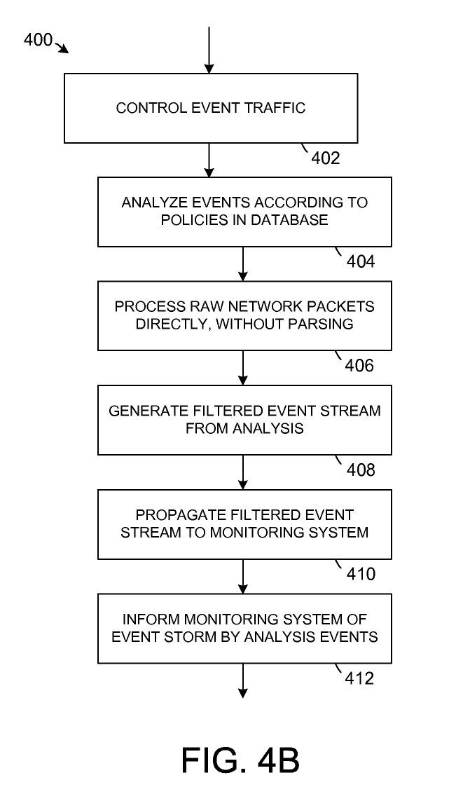

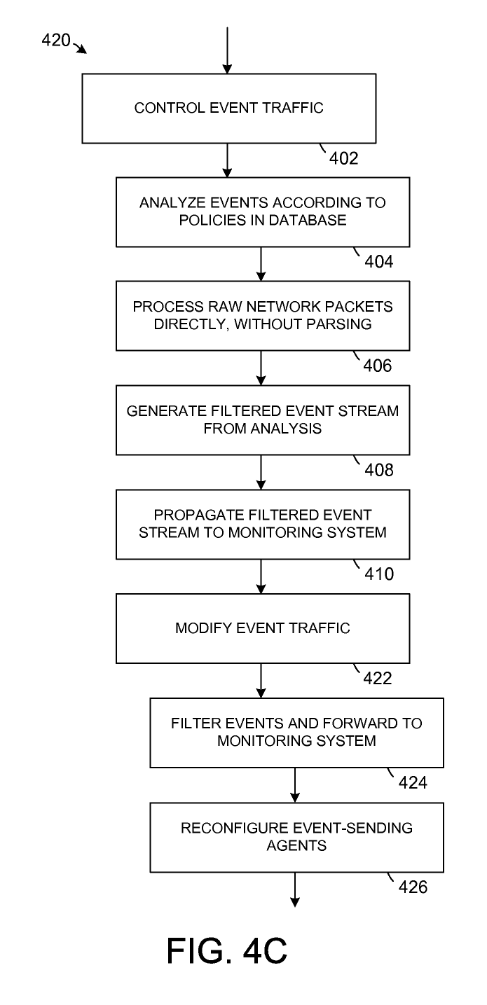

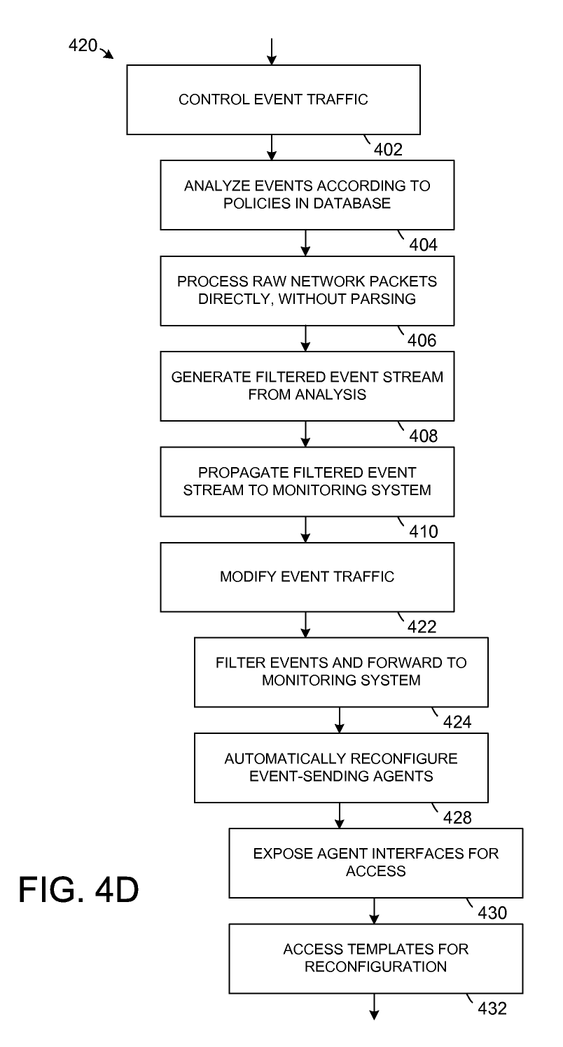

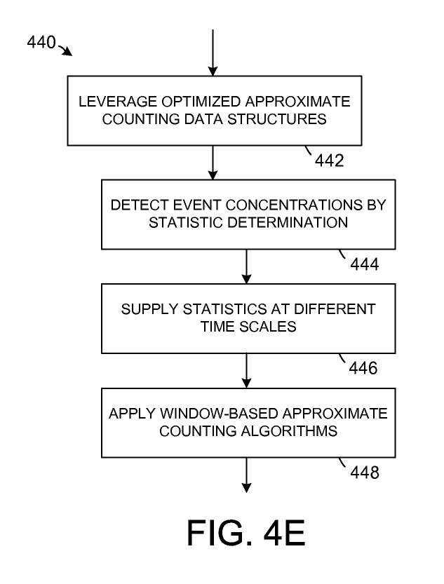

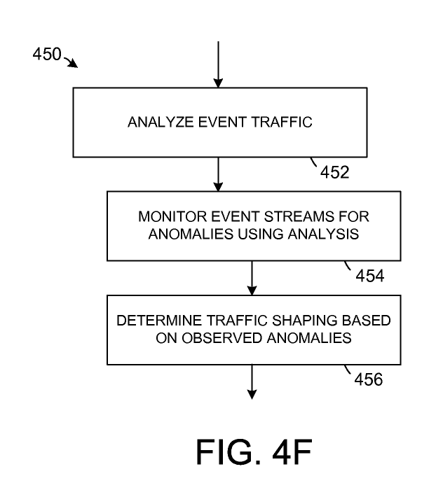

Referring to FIGS. 4A through 4F, flow charts illustrate one or more embodiments or aspects of a computer-executed method for managing event traffic in a network system. FIG. 4A depicts a computer-executed method 400 for operating the network system and handling event storms. The illustrative method 400 comprises analyzing and controlling 402 event traffic by analyzing 404 events according to policies specified in a policies database, and processing 406 raw network packets directly with less than full packet parsing. Analyzing and controlling 402 event traffic can further comprise generating 408 a filtered stream of events based on the analysis, and propagating 410 the filtered stream of events to a monitoring system.

Referring to FIG. 4B, in some embodiments a computer-executed method for operating the network system and handling event storms can further comprise informing 412 the monitoring system about elevated event occurrence levels via analysis events.

Referring to FIG. 4C, a computer-executed method 420 for operating the network system in a detected condition of elevated event traffic can further modify traffic 422 by filtering 424 events before forwarding the events to the monitoring system, and then reconfiguring 426 event-sending agents to reduce the number of events that are sent.

Referring to FIG. 4D, in an example implementation the event-sending agents can be reconfigured by automatic reconfiguration 428 of the remote agents. The automatic reconfiguration 428 can be performed by exposing 430 agent interfaces for access, and accessing 432 templates for performing reconfiguration.

Referring to FIG. 4E, a computer-executed method 440 for operating the network system can comprise leveraging 442 optimized approximate counting data structures. The leveraging technique 442 can comprise continuously detecting 444 event concentrations by determination of at least one statistic over the stream of events, and supplying 446 the one or more statistics at different time scales. The leveraging technique 442 can further comprise applying 448 window-based approximate counting algorithms.

In an example implementation, the one or more statistics can be selected from parameters regarding entities including top-K sources, event-types, (source, event)-tuples of the data structures, sources with an event rate extending past a predetermined threshold, event-types with an event rate extending past a predetermined threshold, (source, event)-tuples of the data structures with an event rate extending past a predetermined threshold, and the like.

Different statistics can be monitored at selected fine-grain and coarse-grain time scales over incoming events.

Referring to FIG. 4F, a computer-executed method 450 for operating the network system can perform analysis 452 of event traffic comprising monitoring 454 event streams for anomalies using analysis algorithms, and determining 456 traffic shaping based on the observed anomalies.

In various embodiments, event traffic can be shaped 456 using one or more techniques such as dropping uniformly random events, dropping all events from a selected source, dropping all events of a selected event type, informing of anomalies via analysis of events with no events dropped, configuring at least one agent using database templates to reduce events from the at least one agent, and the like. Multiple event traffic shaping methods can be performed simultaneously.

In some embodiments, the technique for analyzing and controlling event traffic can be implemented in a push-based monitoring system in which agents on the monitored devices or local aggregators push system monitoring data as events to a central management server.

In other embodiments or selected conditions, the technique for analyzing and controlling event traffic can be implemented in a pull-based monitoring system wherein agents at end devices are queried for events from a central management server.

Clusters of event traffic on a network system, which can be called event storms, can occur in monitoring systems such as push-based monitoring systems in which agents on the monitored devices or local aggregators push system monitoring data as events to a central management server. Examples of events can include alarms or traps as in a network manager software installation or messages as in an operations product installation. For example, in the network manager context, several scenarios can result in large event storms. An event storm can result when a wide area network (WAN) router fails and many (for example, several hundreds) edge routers connected to the Internet via the WAN router generate alerts simultaneously. An event storm can also occur for a router that is incorrectly configured to low threshold values for generating alerts. A further cause of event storms is noisy devices that emit a large number of traps of little value to a monitoring system.

In an operations context, a scenario for occurrence of event storms is application agents that lose connection to a management server, for example due to network problems, and buffer all generated messages, then storming the buffered messages to the server once connectivity is established.

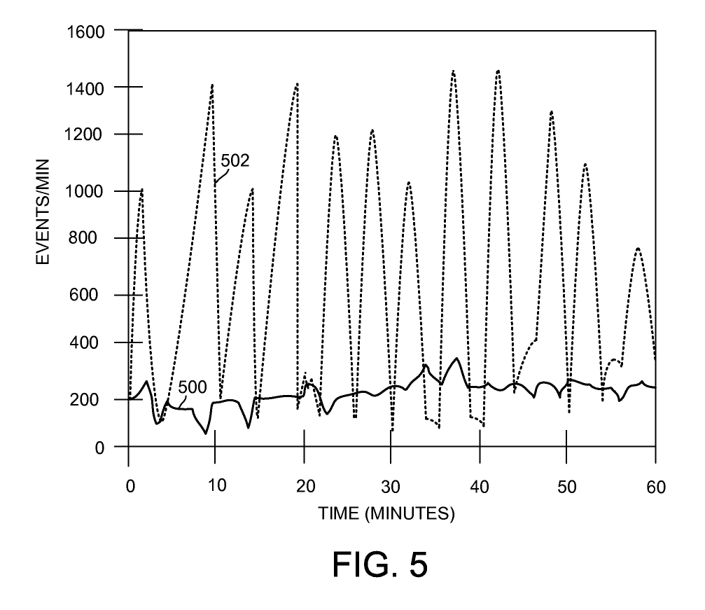

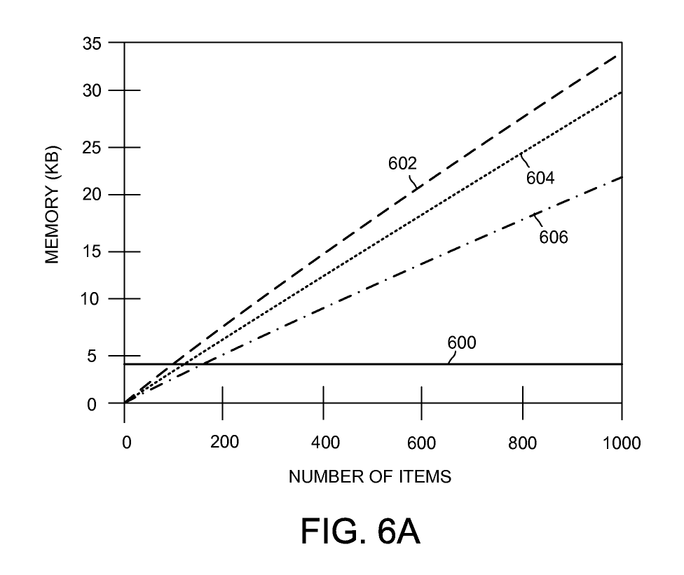

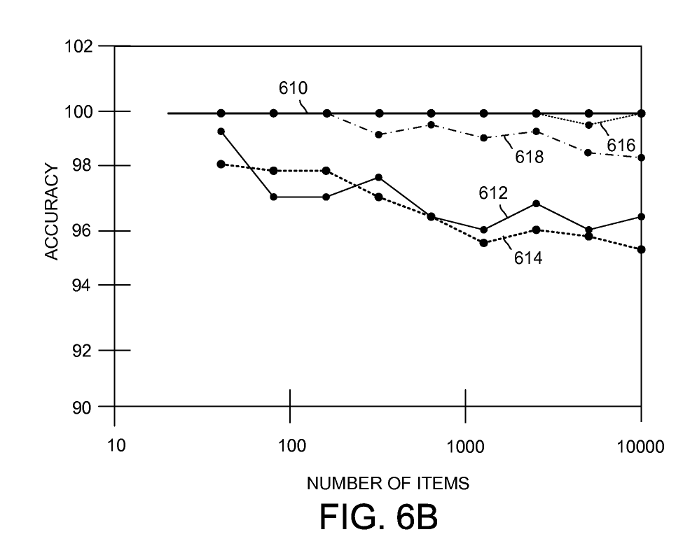

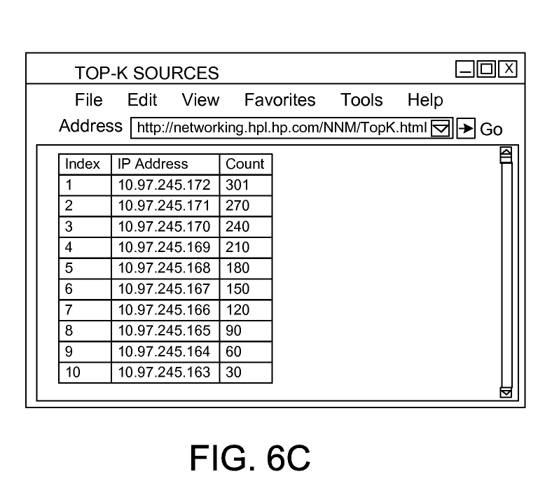

As shown in FIG. 5, a graph depicts an example time sample of event traffic in a network. In case of an event storm, a central event receiver of a network manager installation in a customer setting can observe a substantial increase (in the particular illustrative example up to a seven-fold increase) in the peak event arrival rate 502 compared to a normal operation time 500.

Handling of large-scale event storms is a challenge for current monitoring systems. Monitoring systems that do not address event storms may crash in the face of such storms either due to running out of available memory for processing or CPU thrashing that occurs with event overload. For example, in the case of a persistent storm as shown in FIG. 5, a network manager trap execution module that receives and processes events, crashes with out-of-memory errors. Buffering can alleviate some event storms that occur in bursts over a short time, but buffering is an insufficient solution for persistent storms. If the arrival rate of events is greater than the processing rate, waiting queues grow unbounded.

Dropping events during storms is a common solution employed by some management products. For example, event reduction techniques in network manager and operations management applications can include an event correlation service circuit that allows suppression of events from specified devices but the strategy of simply suppressing events without any analysis to combat the event storms has several disadvantages. Information in the events that enables insight into the cause of the event storms is lost and thus ignored. With no analysis, event suppression can drop not only events that should be dropped but also important events occurring during storms. Suppression of events without analysis can alleviate problems at the central server while the event storms can disrupt other traffic on the network. Event suppression alone is not a suitable long-term solution since information relating to the profile of trap traffic in operative environment and conditions is valuable to a user, and simple suppression does not give any information.

Referring again to FIG. 1, the scalable event analysis and control engine 102 is implemented to handle event storms in monitoring systems. The scalable event analysis and control engine 102 has several beneficial characteristics including: (i) a small foot-print both in terms of memory and central processing units (CPU) consumption; (ii) a capability to handle event storms gracefully and adapt analysis detail based on the incoming traffic rate; (iii) a capability to report different types of statistics such as top-N sources causing the events, top-N types of events, and the like, or based on user-supplied aggregate functions; (iv) a capability to shape the event traffic if the rate exceeds handling capability of a monitoring system; (v) functionality of controlling event traffic by configuring the devices or agents generating the events; and (vi) support of flexible mechanisms for event analysis, control, and exposure of configurable policies to users. In an example implementation, the event analysis and control engine 102 performs traffic shaping only after informing the user about the analysis of the storm, so that a user can also take other actions that avoid traffic shaping.

FIG. 1 depicts an example architecture of a system 100 which includes the event analysis and control engine 102 which analyzes events 106 passing from agents 108 to a monitoring system 114 according to policies specified in the policies database 110. The event analysis and control engine 102 processes the raw network packets directly without performing full parsing that is typical in current monitoring systems. Accordingly, the event analysis and control engine 102 enables faster processing rates. Based on the analysis, the event analysis and control engine 102 generates a filtered stream of events and propagates the filtered events 112 to the monitoring system 114. An analysis part of the event analysis and control engine 102 also informs the monitoring system 114 and users about the storm occurrences via analysis events 116. The control portion of the event analysis and control engine 102 can shape traffic in two ways. First, the events 106 are filtered and then forwarded to the monitoring system 114. Second, the event analysis and control engine 102 reconfigures agents 108 to send fewer events.

In some conditions and/or embodiments, the system 100 can implement automatic remote reconfiguration of an agent 108 which is enabled by an agent 108 exposing interfaces and the event analysis and control engine 102 allocated access to templates to perform reconfiguration. In the illustrative example shown in FIG. 1, Agents 1, 3, and N are configurable while Agent 2 is not by the event analysis and control engine 102.

One aspect that can be implemented in an event analysis and control engine embodiment is a very small footprint with respect to both memory and computation consumption. For example, naive counting methods that maintain exact counts of events for each source of event or for each event type can quickly fill memory space in a large-scale system (O(N) memory footprint for N distinct items). The illustrative system 100 can be implemented to leverage optimized approximate counting data structures such as count-sketch as described by M. Charikar, K. Chen, and M. Farch-Colton in “Finding Frequent Items in Data Streams,” in International Colloquium on Automata, Languages, and Programming, 2002. The count-sketch algorithm has a lower memory footprint than traditional counting methods because in the illustrative scheme only a constant number of counters are maintained in contrast to counting methods in which a counter is maintained for every unique item. The data structure can be used to determine Top-K sources, event-types, and (source, event type)-tuples to detect the prolific event sources continuously. A top-K query requests for K tuples ordered according to a specific ranking function that combines values from multiple attributes. In addition, to supply statistics at different time scales (for example, Top-K in last minute, last hour, last day), window-based approximate counting algorithms can be leveraged. Leveraging techniques enable monitoring of different statistics at fine-grain to coarse-grain time scales over the incoming events.

As the analysis algorithms monitor the event stream for anomalies, control engine decides how the traffic is shaped based on the observed anomalies. Depending on the policies, the control engine might (i) drop uniformly random events (note that a strategy that uses buffers and drops all events once that buffer fills will not be a uniformly random drop as only packets at the tail are dropped in case of bursts) (ii) drop all events from a source, or of an event type, etc., (iii) just inform about the anomalies to the monitoring system/user via analysis events and not drop any events, or (iv) configure one or more agents using templates in the database to reduce the events from those agents.

Referring to FIGS. 6A, 6B, and 6C, graphs and a display screen show an example operation of an implementation of the disclosed event storm handling system and associated operating method. The event analysis and control engine can be implemented in a network manager. An illustrative COUNT SKETCH algorithm maintains approximate counts for a large number of sources or event types. FIG. 6A shows memory consumption of naive exact counting algorithms versus a count-sketch algorithm 600 incorporating analysis by the event analysis and control engine as the number of unique items to count is varied. In the example implementation, the count-sketch algorithm is configured to use 1024 counters in total. FIG. 6A shows curves for naive counting of events from sources alone 602, counting of different eventTypes 604, and counting of different (source, eventType) tuples 606. The count-sketch is agnostic to the items counted since the items counted need not be stored and only a constant set of counters is maintained. Even with just 1000 items, the illustrative count-sketch algorithm with analysis achieves a five to eight times reduction in the memory footprint.

FIG. 6B illustrates accuracy of the count-sketch algorithm in detecting Top-K′ when configured to track Top-K items. The approximate counting algorithms that are leveraged in the illustrative system balance accuracy with memory footprint. In FIG. 6B, accuracy of count-sketch algorithms is presented for different configurations of (K,K′) tuples. The count-sketch algorithm is configured to generate output results including the list of Top-K items and measure accuracy based on how many of the Top-K′ items are included in the list. An average of 20 runs of the illustrative count-sketch algorithm is shown against a stream of 100,000 random events spread across different items using a standard Zipf distribution with α=1.1. The depicted count-sketch implementation is able to attain 100% accuracy in (10,10) case 610 even with about 10,000 items in the event stream. Although accuracy for (20,20) 612 and (30,30) 614 is slightly below 100%, 90% of the top items appear in the lists produced by count-sketch with very high accuracy (cases (20,18) 616 and (30,27) 618).

The analysis engine can be implemented as an augmentation to a monitoring system in a network manager application. FIG. 6C shows a snapshot of a browser output screen from an implementation of the event analysis and control engine in a network manager application in comparison to an artificial event trace.

In further embodiments and applications, a control loop can be implemented that includes the event analysis and control engine using the Top-K statistics from analysis algorithms to reconfigure certain agents to reduce the number of events. The illustrative techniques are also applicable to any monitoring system that employs a pull-based approach in which agents at end devices push events to a central management server. Accordingly, the illustrative system and techniques are applicable to other monitoring applications including Telecom event management systems and operations management systems.

Functionality of the event analysis and control engine and associated techniques extends beyond setting of rules for detection of simple event storm events, counting of the events of a type, checking for counts beyond a threshold in a specified time window, and enablement of users to write rules for dropping events on detection of storms. Functionality of the event analysis and control engine and associated techniques is greatly enhanced to support control functions to reconfigure the agents that send the events and includes optimized analysis engine for detecting storms.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A controller-executed method for managing event traffic in a network system comprising:
analyzing and controlling event traffic comprising:
analyzing events according to policies specified in a policies database;
processing raw network packets directly with less than full packet parsing;
generating a filtered stream of events based on the analysis; and
propagating the filtered stream of events to a monitoring system.

2. The method according to claim 1 further comprising:
informing the monitoring system about elevated event occurrence levels via analysis events.

3. The method according to claim 1 further comprising:
modifying traffic comprising:
filtering events before forwarding to the monitoring system; and
reconfiguring event sending agents to reducing sending of events.

4. The method according to claim 1 further comprising:
automatically reconfiguring remote agents comprising:
exposing agent interfaces for access; and
accessing templates for performing reconfiguration.

5. The method according to claim 1 further comprising:
leveraging optimized approximate counting data structures comprising:
continuously detecting event concentrations by determination of at least one statistic over the stream of events;
supplying the at least one statistic at different time scales; and
applying window-based approximate counting algorithms, wherein the at least one statistic is selected from parameters regarding entities consisting of top-K sources, event-types, (source, event)-tuples of the data structures, sources with an event rate extending past a predetermined threshold, event-types with an event rate extending past a predetermined threshold, and (source, event)-tuples of the data structures with an event rate extending past a predetermined threshold; and
monitoring different statistics selectively at fine-grain and coarse-grain time scales over incoming events.

6. The method according to claim 1 further comprising:
monitoring event streams for anomalies using analysis algorithms;
determining traffic shaping based on the observed anomalies; and
shaping event traffic comprising at least one method selected from a group consisting of:
dropping uniformly random events;
dropping all events from a selected source;
dropping all events of a selected event type;
informing of anomalies via analysis of events with no events dropped;
configuring at least one agent using database templates to reduce events from the at least one agent; and
performing a plurality of event traffic shaping methods simultaneously.

7. The method according to claim 1 further comprising:
analyzing and controlling event traffic in a push-based monitoring system; wherein agents at end devices push events to a central management server.

8. A network system comprising:
an event analysis and control engine that receives events from a plurality of agents, analyzes the events according to policies specified in a policies templates database, and processes raw network packets directly with less than full packet parsing to generate a filtered stream of events based on the analysis, the event analysis and control engine configured to propagate the filtered stream of events to a monitoring system.

9. The system according to claim 8 further comprising:
the policies templates database coupled to the event analysis and control engine that supplies policies templates for analysis; and
the monitoring system coupled to the event analysis and control engine that receives filtered events and analysis events modified by shaping by the event analysis and control engine.

10. The system according to claim 8 further comprising:
at least one agent coupled to the event analysis and control engine that receives a configuration from and communicates events to the event analysis and control engine.

11. The system according to claim 8 further comprising:
the event analysis and control engine configured to inform the monitoring system about elevated event occurrence levels via analysis events and modify traffic by filtering events and forwarding the filtered events to the monitoring system, and reconfiguring event-sending agents to send fewer events;
the event analysis and control engine configured for conserving memory and computation consumption by leveraging optimized approximate counting data structures comprising continuously detecting event concentrations by determination of at least one statistic over the stream of events, and applying window-based approximate counting algorithms; and
a user interface coupled to the event analysis and control engine enabling a user to select monitoring of different statistics at selected fine-grain and coarse-grain time scales over incoming events.

12. The system according to claim 8 further comprising:
the event analysis and control engine configured for monitoring event streams for anomalies using analysis algorithms and determining event traffic shaping based on the observed anomalies, the event traffic shaping selectively comprising at least one method selected from a group consisting of:
dropping uniformly random events;
dropping all events from a selected source;
dropping all events of a selected event type;
informing of anomalies via analysis of events with no events dropped;
configuring at least one agent using database templates to reduce events from the at least one agent; and
performing a plurality of event traffic shaping methods simultaneously;
the event analysis and control engine configured for analyzing and controlling event traffic in a push-based monitoring system, and configured for analyzing and controlling event traffic in a pull-based monitoring system wherein agents at end devices push events to a central management server.

13. The system according to claim 8 further comprising:
an article of manufacture comprising:
a controller-usable medium having a computer readable program code embodied in a controller for managing event traffic in a network system, the computer readable program code further comprising:
code causing the controller to analyze events according to policies specified in a policies database;
code causing the controller to process raw network packets directly with less than full packet parsing;
code causing the controller to generate a filtered stream of events based on the analysis; and
code causing the controller to propagate the filtered stream of events to a monitoring system.

14. A network system comprising:
an event analysis and control engine that receives events from a plurality of agents, analyzes the events, and processes raw network packets directly in a closed-loop control system that conserves memory and computation consumption by continuously detecting event concentrations, determining at least one statistic over the stream of events, and executing a count-sketch window-based approximate counting algorithm.

15. The system according to claim 14 further comprising:
the policies templates database coupled to the event analysis and control engine that supplies policies templates for analysis;
a monitoring system coupled to the event analysis and control engine that receives filtered events and analysis events modified by shaping by the event analysis and control engine;
at least one agent coupled to the event analysis and control engine that receives a configuration from and communicates events to the event analysis and control engine; and
the event analysis and control engine configured to detect anomalies and selectively respond by temporarily terminating receipt of traps from a source agent of the anomaly, temporarily terminating receipt of a specified event from a source agent, enabling a user to control behavior according to the analysis, and spawning additional trap processors according to the analysis.
